(19) United States
(12) Patent Application Publication
(10) Pub. No.: US 2023/0082171 A1
(43) Pub. Date: Mar. 16, 2023

(54) CERAMIC FORGING METHOD

(71) Applicant: Zhengzhou University of Aeronautics, Zhengzhou City (CN)

(72) Inventors: Lei FAN, Zhengzhou City (CN); Linan AN, Zhengzhou City (CN)

(21) Appl. No.: 17/930,783

(22) Filed: Sep. 9, 2022

(30) Foreign Application Priority Data
Sep. 13, 2021 (CN) 202111070081.9

(51) Int. Cl. C04B 40/02; C04B 35/563

(52) U.S. Cl. CPC C04B 40/0259; C04B 35/563; C04B 2235/3821; C04B 2235/96

(57) ABSTRACT

The present disclosure relates to a ceramic forging method, and belongs to the technical field of ceramic preparation. The ceramic forging method comprises a step of applying an oscillatory pressure to to-be-forged ceramic at a forging temperature to perform forging, In accordance with the ceramic forging method provided by the present disclosures, the deformation capacity and the deformation rate of a ceramic material are improved by changing a deformation mechanism of a ceramic material at the high temperature through oscillatory pressure, such that generation of micro fatigues inside the ceramic material and the deformation process of the material are greatly improved, then the ceramic material can reach the higher deformation rate and the larger deformation amount at lower temperature and pressure, and therefore ceramic forging can be achieved, and the cost is greatly reduced.

### CROSS REFERENCE TO RELATED APPLICATION

This patent application claims the benefit and priority of Chinese Patent Application No. 202111070081.9 filed on Sep. 13, 2021, the disclosure of which is incorporated by reference herein in its entirety as part of the present application.

### TECHNICAL FIELD

The present disclosure relates to a ceramic forging method, and belongs to the technical field of ceramic preparation.

### BACKGROUND ART

Forging is a method for plastically deforming materials by pressure to obtain certain shapes, sizes and properties. Forging is commonly used in the forming of metal materials, but the ceramic materials are difficult to be forged because of their difficulty in gliding and poor plasticity. The common preparation method of high-performance ceramic components is mainly hot-pressed sintering. Compared with the hot-pressed sintering, the forging process generates larger shear stress inside the material to make the material generate larger deformation, which not only can greatly eliminate the pore structures inside the material, but also can generate texture structures and work hardening so as to greatly improve the performance of the material.

Ceramic materials are mostly bonded by ionic bonds and covalent bonds, which makes dislocation generation and movement of ceramic materials difficult. Although the stress required for deformation is gradually reduced along with the improvement of the activity capacity of atoms at high temperature, higher temperature and pressure are still required for achieving ceramic forging. Under existing static pressure conditions, the high-temperature creep mechanism of ceramic materials is mainly based on Coble and Naborro-Herring diffusion mechanisms, with small strain amount and low strain rate. If the deformation mechanism needs to be improved to power law deformation mechanism dominated by glide or dislocation to achieve the effect of improving the strain amount and the strain rate, very high temperature and extremely high static pressure are required, which often exceed the tolerance range of equipment and high-temperature, molds such as graphite molds. Therefore, the ceramic forging is difficult to achieve or requires extremely high cost.

### SUMMARY

An objective of the present disclosure s to provide a ceramic forging method, which may reduce cost for ceramic forging.

To achieve the objective above, the present disclosure employs the following technical solutions:

A ceramic forging method comprises a step of applying an oscillatory pressure to to-be-forged ceramic at a forging temperature to perform forging.

In accordance with the ceramic forging method, the deformation capacity and the deformation rate of a ceramic material are improved by changing a deformation mechanism of a ceramic material at the high temperature through the oscillatory pressure, such that generation of micro fatigues inside the ceramic material and the deformation process of the material are greatly improved, then a high-temperature deformation mechanism of the ceramic material may reach a higher deformation rate and the larger deformation amount at lower temperature and pressure, and therefore ceramic forging can be achieved, and the cost is greatly reduced. In addition, the deformation process generated by oscillatory pressure forging may improve the relative density and enhance the performance of the ceramic material, and may also achieve forging forming of ceramic components in certain shapes and sizes.

Preferably, the oscillatory pressure and the forging temperature are configured to meet the following condition that the to-be-forged ceramic has a stress exponent greater than or equal to 2 when deformed at a median pressure of the oscillatory pressure and the under the forging temperature. When the stress exponent is greater than or equal to 2, the deformation mechanism follows power law deformation dominated by grain boundary sliding or dislocation creep. The forging temperature is higher than the creep temperature of the to-be-forged ceramic.

A median pressure of the oscillatory pressure is selected in match with the forging temperature. Preferably, an amplitude of the oscillatory pressure is 8% to 100% of the median pressure of the oscillatory pressure, such as 12.5%, 14.2% or 20%.

Preferably, the median pressure of the oscillatory pressure is 40 MPa to 120 MPa, such as 50 MPa, 70 MPa, 80 MPa, or 100 MPa.

Preferably, the frequency of the oscillatory pressure is 1 Hz to 20 Hz, such as 5 Hz or 10 Hz.

Preferably, the waveform of the oscillatory pressure is a sine wave or a cosine wave.

Preferably, the to-be-forged ceramic has a relative density of 60% to 100%. In accordance with the ceramic forging method provided by the present disclosure, after being forged by using the ceramic forging method, the to-be-forged ceramic having a relative density of 99% or less may be further densification so as to improve the relative density. For dense (relative density greater than or equal to 99%) or non-dense (relative density less than 99%) to-be-forged ceramic, the strength and hardness of the forged ceramic are improved.

Preferably, the forging time is 0.5 h to 2 h, such as 1 h.

Preferably, the to-be-forged ceramic is liquid-phase sintered ceramic or solid-phase sintered ceramic. The liquid-phase sintered ceramic is a ceramic material containing an intergranular glass phase or an amorphous phase. For example, the liquid-phase sintered ceramic is liquid-phase sintered silicon nitride ceramic or liquid-phase sintered aluminum nitride ceramic. The solid-phase sintered ceramic is ceramic with no intergranular glass phase or an intergranular amorphous phase. Preferably, the solid-phase sintered ceramic is boron carbide ceramic or alumina ceramic. The to-be-forged ceramic may be ceramic added with sintering aids during preparation, and may also be ceramic without the aids during sintering.

When the to-be-forged ceramic is the boron carbide ceramic, the forging temperature is preferably 1800° C. to 2000° C., and the median pressure of the oscillatory pressure is 50 MPa to 70 MPa.

When the to-be-forged ceramic is the silicon nitride ceramic, the forging temperature is preferably 1600° C. to 1800° C., and the median pressure of the oscillatory pressure is 40 MPa to 70 MPa.

When the to-be-forged ceramic is the alumina ceramic, the forging temperature is preferably 1500° C. to 1800° C., and the median pressure of the oscillatory pressure is 70 MPa to 120 MPa.

The to-be-forged ceramic has already been sintered and produced a sintered bond before being forged by applying oscillatory pressure. The to-be-forged ceramic in sintered bond may be a ceramic material which is sintered prior to forging and taken out after being cooled, or the sinter generated during heating prior to applying the oscillatory pressure. The sintering may be pressure sintering or pressure-less sintering. Meanwhile, the sintering may be carried out with the sintering aids or without the sintering aid. Preferably, the to-be-forged ceramic is obtained by pressure sintering or pressure-less sintering, then the to-be-forged ceramic is heated to the forging temperature, and is forged at the forging temperature by applying the oscillatory pressure.

### BRIEF DESCRIPTION OF THE DRAWINGS

FIG. 1 is a morphological diagram of to-be-forged ceramic and forged ceramic an embodiment 1.

### DETAILED DESCRIPTION OF THE EMBODIMENTS

The technical solutions of the present disclosure are further described below with reference to specific embodiments.

### Embodiment 1

A ceramic forging method of this embodiment, using hot-pressed sintered boron carbide ceramic (in a shape of a cylinder having a diameter of 30 mm and a height of 4.61 mm, and having a relative density of 98%) without the addition of a sintering aid as to-be-forged ceramic, comprises the following steps:

placing the to-be-forged ceramic in a graphite mold having a diameter of 40 mm, and putting the graphite mold filled with the to-be-forged ceramic into a high-temperature furnace, heating to a forging temperature of 1900° C. under a vacuum condition, and preserving heat for 1 hour; loading oscillatory pressure in the heat preservation stage, wherein the oscillatory pressure has a waveform of a sine wave, a frequency of 5 Hz, the median pressure of 70 MPa, and an amplitude of 10 MPa; and obtaining a boron carbide forged part having a diameter of 40 mm and a height of 2.78 mm after performing oscillatory forging for 1 hour, wherein the to-be-forged ceramic has a stress exponent n=3.38 when deformed at 1900° C. and 70 MPa.

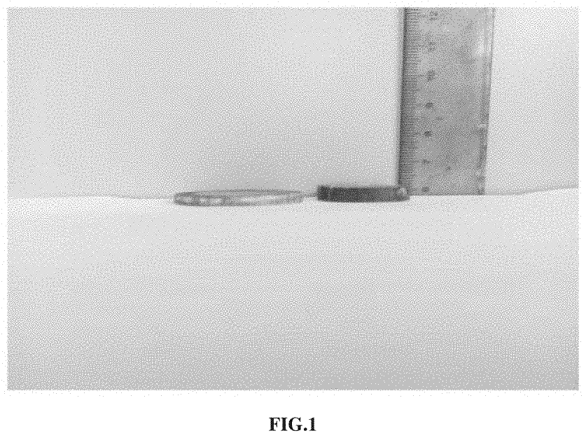

The obtained to-be-forged ceramic and the forged part after forging are as shown in FIG. 1. The obtained boron carbide ceramic forged part has a relative density of 99.5%, a Vickers hardness increased from the 28 GPa of the to-be-forged ceramic to 36 GPa of the forged part, and a bending strength increased from 270 MPa of the to-be-forged ceramic to 620 MPa of the forged part.

### Embodiment 2

A ceramic forging method of this embodiment, using hot-pressed sintered boron carbide ceramic (in a shape of a cylinder having a diameter of 30 mm and a height of 5 mm, and having a relative density of 99.7%) without addition of a sintering aid as to-be-forged ceramic, comprises the following steps:

placing the to-be-forged ceramic in a graphite mold having a diameter of 40 mm, and putting the graphite mold filled with the to-be-forged ceramic into a high-temperature furnace, heating to a forging temperature of 2000° C. under a vacuum condition, and preserving heat for 1 hour; loading oscillatory pressure in the heat preservation stage, wherein the oscillatory pressure has a waveform of a sine wave, a frequency of 20 Hz, the median pressure of 50 MPa, and an amplitude of 10 MPa; and obtaining a boron carbide forged part having a diameter of 40 mm after performing oscillatory forging for 1 hour, wherein the to-be-forged ceramic has a stress exponent n=3.63 when deformed at 2000° C. and 50 MPa.

The obtained boron carbide ceramic forged part has a relative density of 99.7%, a Vickers hardness increased from the 30 GPa of the to-be-forged ceramic to 36 GPa of the forged part, and a bending strength increased from 315 MPa of the to-be-forged ceramic to 670 MPa of the forged part.

### Embodiment 3

A ceramic forging method of this embodiment, using silicon nitride carbide ceramic (liquid-phase sintered silicon nitride ceramic, having a relative density of 80%) added with Y₂O₃ in a mass ratio of 10% as a sintering aid as to-be-forged ceramic, comprises the following steps:

placing the to-be-forged ceramic in a graphite mold, heating to 1800° C. under a nitrogen atmosphere for heat preservation; loading oscillatory pressure, wherein the oscillatory pressure has an oscillatory waveform of a sine wave, a frequency of 5 Hz, the median pressure of 70 MPa, and an amplitude of 10 MPa; and obtaining a deformed silicon nitride ceramic forged part by performing oscillatory forging for 1 hour, wherein the to-be-forged ceramic has a stress exponent n=2.2 at 1800° C. and 70 MPa.

The obtained silicon nitride ceramic forged part has a relative density of 98%, a Vickers hardness increased from the original 9 GPa to 14 GPa, and a bending strength increased from 320 MPa to 710 MPa.

### Embodiment 4

A ceramic forging method of this embodiment, using silicon nitride ceramic (liquid-phase sintered silicon nitride ceramic, having a relative density of 72%) added with Li₂O in a mass ratio of 2% and Y₂O₃ in a mass ratio of 10% as sintering aids and sintered without pressure at 1500° C. as to-be-forged ceramic, comprises the following steps:

placing the to-be-forged ceramic in a graphite mold, heating to 1600° C. under a nitrogen atmosphere for heat preservation; loading oscillatory pressure, wherein the oscillatory pressure has an oscillatory waveform of a sine wave, a frequency of 5 Hz, the median pressure of 40 MPa, and an amplitude of 30 MPa; and obtaining a deformed silicon nitride ceramic forged part after performing oscillatory forging for 1 hour, wherein the to-be-forged ceramic has a stress exponent n=2.1 at 1600° C. and 40 MPa.

The obtained silicon nitride ceramic forged part has a relative density of 96%, a Vickers hardness increased from the original 6 GPa to 12 GPa, and a bending strength increased from 230 MPa to 640 MPa.

### Embodiment 5

A ceramic forging method of this embodiment, using solid-phase sintered alumina ceramic (having a relative density of 99.4%) without the addition of a sintering aid as to-be-forged ceramic, comprises the following steps:

placing the to-be-forged ceramic in a graphite mold, heating to 1600° C. for heat preservation; loading oscillatory pressure, wherein the oscillatory pressure has an oscillatory waveform of a sine wave, a frequency of 1 Hz, the median pressure of 120 MPa, and an amplitude of 10 MPa; and obtaining a deformed alumina ceramic forged part by performing oscillatory forging for 1 hour, wherein the to-be-forged ceramic has a stress exponent n=3.12 when deformed at 1600° C. and 120 MPa.

The obtained alumina ceramic forged part has a relative density of 99.8%, a Vickers hardness increased from the original 14 GPa to 16 GPa, and a bending strength increased from 330 MPa to 400 MPa.

What is claimed is:

1. A ceramic forging method, comprising a step of applying an oscillatory pressure to to-be-forged ceramic at a forging temperature to perform forging.

2. The ceramic forging method according to claim 1, wherein, the oscillatory pressure and the forging temperature are configured to meet the following condition that the to-be-forged ceramic has a stress exponent greater than or equal to 2 when deformed at a median pressure of the oscillatory pressure and under the forging temperature.

3. The ceramic forging method according to claim 1, wherein an amplitude of the oscillatory pressure is 8% to 100% of the median pressure of the oscillatory pressure.

4. The ceramic forging method according to claim 2, wherein an amplitude of the oscillatory pressure is 8% to 100% of the median pressure of the oscillatory pressure.

5. The ceramic forging method according to claim 1, wherein the median pressure of the oscillatory pressure is 40 MPa to 120 MPa.

6. The ceramic forging method according to claim 2, wherein the median pressure of the oscillatory pressure is 40 MPa to 120 MPa.

7. The ceramic forging method according to claim 1, wherein the frequency of the oscillatory pressure is 1 Hz to 20 Hz.

8. The ceramic forging method according to claim 2, wherein the frequency of the oscillatory pressure is 1 Hz to 20 Hz.

9. The ceramic forging method according to claim 1, wherein the waveform of the oscillatory pressure is a sine wave or a cosine wave.

10. The ceramic forging method according to claim 2, wherein the waveform of the oscillatory pressure is a sine wave or a cosine, wave.

11. The ceramic forging method according to claim 1, wherein the to-be-forged ceramic has a relative density of 60% to 100%.

12. The ceramic forging method according to claim 2, wherein the to-be-forged ceramic has a relative density of 60% to 100%.

13. The ceramic forging method according to claim 1, wherein the forging time is 0.5 h to 2 h.

14. The ceramic forging method according to claim 2, wherein the forging time is 0.5 h to 2 h.

15. The ceramic forging method according to claim 1, wherein the to-be-forged ceramic is liquid-phase sintered ceramic or solid-phase sintered ceramic.

16. The ceramic forging method according to claim 2, wherein the to-be-forged ceramic is liquid-phase sintered ceramic or solid-phase sintered ceramic.

17. The ceramic forging method according to claim 1,wherein when the to-be-forged ceramic is boron carbide ceramic, the forging temperature is 1800° C. to 2000° C., and the median pressure of the oscillatory pressure is 50 MPa to 70 MPa; when the to-be-forged ceramic is silicon nitride ceramic, the forging temperature is 1600° C. to 1800° C., and the median pressure of the oscillatory pressure is 40 MPa to 70 MPa; when the to-be-forged ceramic is alumina ceramic, the forging temperature is 1500° C. to 1800° C., and the median pressure of the oscillatory pressure is 70 MPa to 120 MPa.

18. The ceramic forging method according to claim 2, therein when the to-be-forged ceramic is boron carbide ceramic, the forging temperature is 1800° C. to 2000° C., and the median pressure of the oscillatory pressure is 50 MPa to 70 MPa; when the to-be-forged ceramic is silicon nitride ceramic, the forging temperature is 1600° C. to 1800° C., and the median pressure of the oscillatory pressure is 40 MPa to 70 MPa; when the to-be-forged ceramic is alumina ceramic, the forging temperature is 1500° C. to 1800° C., and the median pressure of the oscillatory pressure is 70 MPa to 120 MPa.
